(19) United States
(12) Patent Application Publication
(10) Pub. No.: US 2026/0259594 A1
(43) Pub. Date: Sep. 3, 2026

(54) DATA PROCESSING DEVICE, DATA PROCESSING METHOD, DATA PROCESSING SYSTEM, AND SENSOR SYSTEM

(71) Applicant: SONY GROUP CORPORATION, TOKYO (JP)

(72) Inventor: MAMUN KAZI, KANAGAWA (JP)

(21) Appl. No.: 19/159,624

(22) PCT Filed: Feb. 20, 2024
(86) PCT No.: PCT/JP2024/005924

§ 371 Date: Aug. 26, 2025

(30) Foreign Application Priority Data
Mar. 9, 2023 (JP) 2023-036260

(51) Int. Cl. G06F 1/3234; G06F 1/3296

(52) U.S. Cl. CPC G06F 1/3275; G06F 1/3296

(57) ABSTRACT

The present disclosure relates to a data processing device, a data processing method, a data processing system, and a sensor system aimed to reduce memory power consumption. Provided is a data processing device including: a memory that is partitioned into a plurality of memory banks and stores data used in DNN processing; a holding unit that is provided for each of the memory banks and retains usage status information indicating a usage status of the data stored in each memory word; and a power management unit that brings power to the memory bank where all the pieces of data stored in each memory word have been used from an on state into an off state or a low-power state where the memory banks operate with reduced power compared to the on state on the basis of the usage status information that has been retained. The present disclosure is applicable to, for example, a sensor system including an image sensor.

### TECHNICAL FIELD

The present disclosure relates to a data processing device, a data processing method, a data processing system, and a sensor system, and more particularly, to a data processing device, a data processing method, a data processing system, and a sensor system aimed to reduce memory power consumption.

### BACKGROUND ART

With the widespread adoption of the Internet of Things (IoT), it is expected that AI functionality for extracting meaningful information from a large volume of sensor data and deep neural network (DNN) processing to enable the AI functionality will be implemented in various edge devices including sensors (for example, see Patent Document 1).

Such edge devices have very limited power budgets, which makes it essential to reduce the power consumption in DNN processing. The majority of power consumption in DNN processing is attributed to memory access, which occasionally accounts for 80% to 90%. To achieve and promote the widespread adoption of low-power edge devices, it is necessary to reduce the power consumption of memory access in DNN processing.

### CITATION LIST

### Patent Document

Patent Document 1: Japanese Patent Application Laid-Open No. 2022-041873

### SUMMARY OF THE INVENTION

### Problems to be Solved by the Invention

Currently, however, there is no established technological approach for reducing the power consumption of memory access in DNN processing, and there has been a growing demand for proposals aimed to reduce memory power consumption.

The present disclosure has been made in view of such circumstances, and aims to reduce memory power consumption.

### Solutions to Problems

A data processing device according to one aspect of the present disclosure includes: a memory that is partitioned into a plurality of memory banks and stores data used in DNN processing; a holding unit that is provided for each of the memory banks and retains usage status information indicating a usage status of the data stored in each memory word; and a power management unit that brings power to the memory bank where all the pieces of data stored in each memory word have been used from an on state into an off state or a low-power state where the memory banks operate with reduced power compared to the on state on the basis of the usage status information that has been retained.

A data processing method according to one aspect of the present disclosure includes: causing a data processing device to retain, for each memory bank obtained by partitioning a memory that stores data used in DNN processing into a plurality of the memory banks, usage status information indicating a usage status of the data stored in each memory word; and causing the data processing device to bring power to the memory bank where the all the pieces of data stored in each memory word have been used from an on state into an off state or a low-power state where the memory banks operate with reduced power compared to the on state on the basis of the usage status information that has been retained.

A data processing system according to one aspect of the present disclosure includes: a processor; a buffer that stores data received from outside; and a data processing device that is controlled by the processor and to which the data stored in the buffer is input, in which the data processing device includes: a memory that is partitioned into a plurality of memory banks and stores data used in DNN processing; a holding unit that is provided for each of the memory banks and retains usage status information indicating a usage status of the data stored in each memory word; and a power management unit that brings power to the memory bank where all the pieces of data stored in each memory word have been used from an on state into an off state or a low-power state where the memory banks operate with reduced power compared to the on state on the basis of the usage status information that has been retained.

A sensor system according to one aspect of the present disclosure includes: a sensor; and a data processing system that processes data received from the sensor, in which the data processing system includes: a processor; a buffer that stores the data received from the sensor; and a data processing device that is controlled by the processor and to which the data stored in the buffer is input, and the data processing device includes: a memory that is partitioned into a plurality of memory banks and stores data used in DNN processing; a holding unit that is provided for each of the memory banks and retains usage status information indicating a usage status of the data stored in each memory word; and a power management unit that brings power to the memory bank where all the pieces of data stored in each memory word have been used from an on state into an off state or a low-power state where the memory banks operate with reduced power compared to the on state on the basis of the usage status information that has been retained.

In the data processing device, the data processing method, the data processing system, and the sensor system according to one aspect of the present disclosure, for each memory bank obtained by partitioning a memory that stores data used in DNN processing into a plurality of the memory banks, usage status information indicating a usage status of the data stored in each memory word is retained, and power to the memory bank where the all the pieces of data stored in each memory word have been used is brought from an on state into an off state or a low-power state where the memory banks operate with reduced power compared to the on state on the basis of the usage status information that has been retained.

Note that the data processing device, the data processing system, and the sensor system according to one aspect of the present disclosure may each be an independent device or an internal block constituting one device.

### BRIEF DESCRIPTION OF DRAWINGS

FIG. 1 is a diagram for describing four dimensions used in convolution operations.

FIG. 2 is a diagram illustrating a configuration of a sensor system equipped with a DNN accelerator.

FIG. 3 is a diagram for describing how to reduce memory power consumption in the DNN accelerator illustrated in FIG. 2.

FIG. 4 is a diagram illustrating a configuration example of an embodiment of a sensor system to which the present disclosure is applied.

FIG. 5 is a diagram for describing how to reduce memory power consumption in the DNN accelerator illustrated in FIG. 4.

FIG. 6 is a diagram for describing an example of a memory configuration implemented in the DNN accelerator illustrated in FIG. 4.

FIG. 7 is a diagram illustrating the order of data usage during convolution adapted to the memory configuration illustrated in FIG. 6.

FIG. 8 is a diagram illustrating a relationship among a value of a status register, an instruction of a power management unit (PMU), and a power state of each memory bank for each step of convolution.

FIG. 9 is a diagram illustrating a control flow of an address generation unit (AGU).

FIG. 10 is a diagram illustrating a control flow of the PMU.

FIG. 11 is a diagram for describing another example of the memory configuration implemented in the DNN accelerator illustrated in FIG. 4.

FIG. 12 is a diagram for describing another example of the memory power control implemented in the DNN accelerator illustrated in FIG. 4.

FIG. 13 is a diagram for describing still another example of the memory configuration implemented in the DNN accelerator illustrated in FIG. 4.

FIG. 14 is a diagram illustrating the order of data usage during convolution adapted to the memory configuration illustrated in FIG. 13.

### MODE FOR CARRYING OUT THE INVENTION

### <Basic Configuration>

Typical processing layers of a feedforward deep neural network (DNN) include a convolution layer and a fully connected layer (hereinafter, referred to as FC layer). The FC layer can be considered a special case of the convolution layer. The fundamental computation of the convolution layer is a multiply-accumulate operation (hereinafter referred to as multiply-accumulate (MAC)). Data handled in the computations of the convolution layer has up to four dimensions.

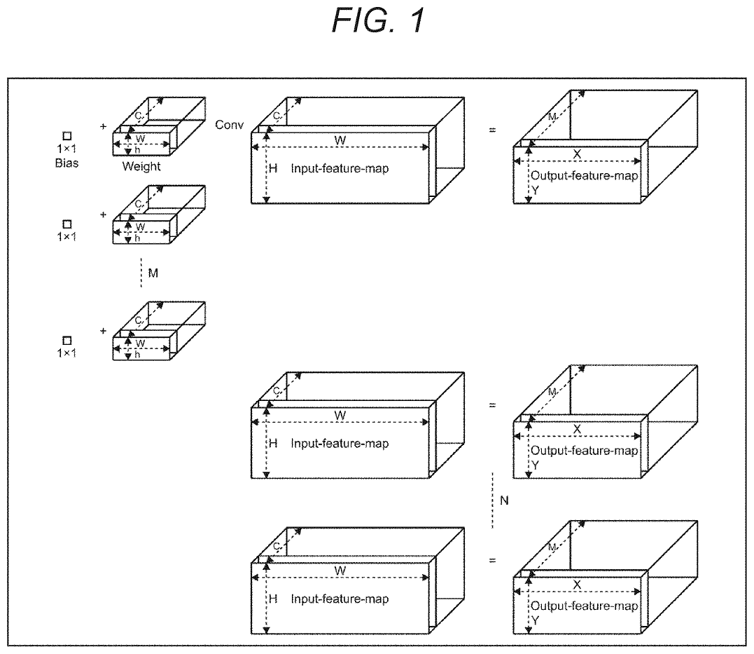

FIG. 1 is a diagram for describing the four dimensions used in the convolution operations. In FIG. 1, the description of each dimension denoted as W, H, C, M, and N and use case examples are given as follows.

W represents the width of an input-feature-map that is a feature map to be input. W corresponds to the first-dimensional data of an image sensor, and is used as the width of an image frame, for example. H represents the height of the input-feature-map. H corresponds to the second-dimensional data of the image sensor, and is used as the height of the image frame, for example.

C represents the number of channels of the input-feature-map and the number of channels in a weight. In a case where convolution is applied to the R, G, and B channels of the image frame or in a case where convolution processing is performed on data received from a plurality of image sensors, a dimension is added to the dimensions of the convolution layer and is defined as a channel.

M represents the number of channels, the number of filters, and the number of biases of an output-feature-map that is a feature map to be output. This dimension is used to adapt the above-described channel concept between the convolution layers. This corresponds to C of the next layer. N represents the number of batches of the input-feature-map and the number of batches of the output-feature-map. This dimension is defined when the input data is divided into a plurality of groups and processed in parallel using the same coefficient.

Note that, here, the five parameters, W, H, C, M, and N, are presented, but the maximum number of dimensions is up to four when focusing on individual data. For example, when focusing on the input-feature-map, the four parameters, W, H, C, and N, are considered, resulting in four dimensions.

Furthermore, FIG. 1 illustrates, in addition to the above-described five parameters, a width X and a height Y of the output-feature-map, and a width w and a height y of the weight as parameters of the convolution layer. Moreover, although not illustrated in FIG. 1, the convolution layer has a slide sw in the width direction and a slide sh in the height direction, each indicating a stride by which the weight is shifted across the input-feature-map.

The convolution can be defined as the following equation (1) using the above-described parameters.

$$\begin{matrix}[ Math . 1 ] & \\ for each Output - feature - map Batch ( 0 ∼ N - 1 ) & ( 1 )\end{matrix}$$

$$for each Output - feature - map Channel ( 0 ∼ M - 1 )$$

$$Output - feature - map Pixel {o}_{x , y} ( x = 0 ∼ X - 1 , y = 0 ∼ Y - 1 ) = {\sum }_{k}^{C - 1} ( {\sum }_{k}^{h - 1} {\sum }_{k}^{w - 1} ( kth\_Input \_feature {\_map}_{x * sw + i , y * sh + j} * {Weight}_{i , j} ) ) + Bias$$

Each pixel in the output-feature-map corresponds to the result of the computation performed in the convolution layer. In the computation, it is not always necessary to iterate the loop of each dimension in the order of i as set in equation (1). For example, in a case of i set in equation (1), the computation result is first output pixel by pixel along the X-dimension of the output-feature-map, but as another example, the computation result may be first output pixel by pixel along the direction of the channel M of the output-feature-map. Regularity in the order of accessing data required for the computation from memory is ensured, regardless of the order in which the computation loop is iterated.

Note that a value obtained by applying an activation function to the result of the MAC operation in convolution is stored as the output-feature-map; therefore, the output-feature-map is hereinafter referred to as activation. Furthermore, this output-feature-map serves as the input-feature-map for the next layer; therefore, the input-feature-map and the output-feature-map are both hereinafter referred to as activation.

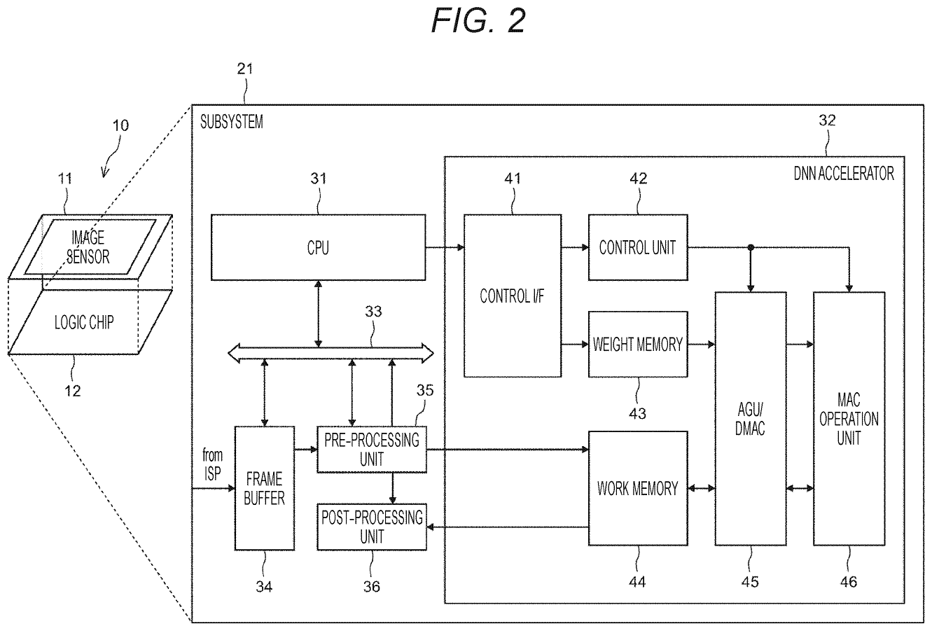

FIG. 2 is a diagram illustrating a configuration of a sensor system equipped with a DNN accelerator. In FIG. 2, a sensor system 10 has a layered structure including an image sensor 11 that captures an image of a subject and outputs a pixel signal and a logic chip 12 including a subsystem 21 for DNN processing.

The pixel signal generated by the image sensor 11 is stored in a frame buffer 34 of the subsystem 21 through image signal processor (ISP) processing. The frame buffer 34 is configured with a static random access memory (SRAM). Weight values necessary for DNN processing are pre-loaded into a weight memory 43 of a DNN accelerator 32 by a central processing unit (CPU) 31. In a case where the chip is designed for a specific use, the weight values are loaded into the weight memory 43 during the chip manufacturing stage. The weight memory 43 is configured with an SRAM in the former case, and is configured with a read only memory (ROM) in the latter case.

A necessary portion of the input-feature-map that the DNN accelerator 32 can process in a single batch is loaded into a work memory 44 of the DNN accelerator 32 by the CPU 31. The work memory 44 is configured with an SRAM. In this state, the CPU 31 controls an AGU/direct memory access controller (DMAC) 45 and a MAC operation unit 46 in accordance with configuration information preset via a control I/F 41 and a control unit 42 to perform MAC operations in the DNN (DNN processing).

The AGU/DMAC 45 includes an AGU circuit that generates an address used to read and write data from and to a memory, and a DMAC circuit that controls access to the memory on the basis of the generated address. The MAC operation unit 46 includes an arithmetic logic unit (ALU) that performs MAC operations. The AGU/DMAC 45 fetches operands to be input to the MAC operation unit 46 from the weight memory 43 or the work memory 44, and this operand fetching is repeated until the MAC operations are completed.

Partial sums of intermediate results from a plurality of MAC operations are also stored in the work memory 44. Note that, in a case where other processing is required before and after DNN processing in the subsystem 21, a pre-processing unit 35 and a post-processing unit 36 can each perform the required processing under the control of the CPU 31 via a bus 33.

The power to the entire sensor system 10 illustrated in FIG. 2 is often kept in the on state even when DNN accelerator 32 is not in use. At this time, even when there is no access to the weight memory 43 or the work memory 44, leakage current flows, resulting in unnecessary power consumption.

In the sensor system 10 illustrated in FIG. 2, to reduce such unnecessary power consumption, the CPU 31, through software, may bring the power to the weight memory 43 or the work memory 44 into the off state or the low-power state when the DNN accelerator 32 is not in use. For example, the low-power state (low-power mode) includes a retention state (data retention mode) defined for the work memory 44. With this approach, however, the power-saving effect cannot be achieved when the DNN accelerator 32 is in use.

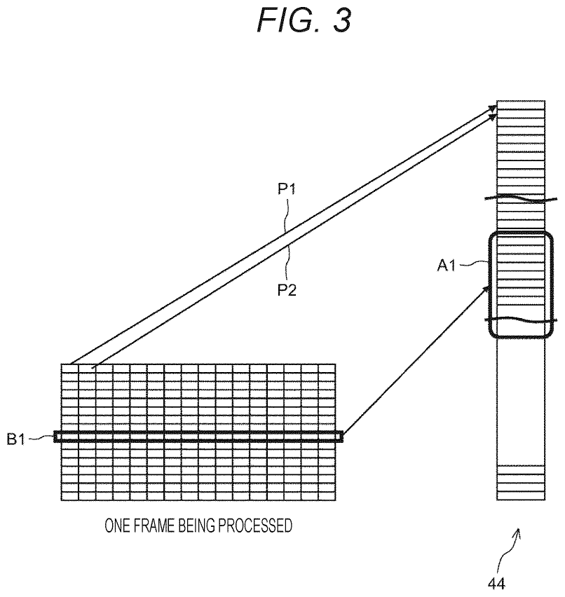

FIG. 3 is a diagram for describing how to reduce memory power consumption in the DNN accelerator 32 illustrated in FIG. 2. FIG. 3 schematically illustrates a relationship between one frame of activation being processed and the arrangement of data of activation on the work memory 44, and each piece of pixel data of (the frame of) activation is stored in the corresponding rectangular area in the work memory 44 (P1, P2, . . . in the drawing). Furthermore, a status of access to the work memory 44 at a specific point in time during DNN processing is indicated by a frame A1, and a position of data being accessed on (the frame of) activation is indicated by a frame B1.

As illustrated in FIG. 3, at a specific point in time during DNN processing, although only a portion of the work memory 44 indicated by the frame A1 is used, the power to the entire memory, including unused portions, is kept in the on state, resulting in unnecessary power consumption. On the other hand, when DNN processing is not performed, the power to the entire memory is brought into the off state or the low-power state through a switch. Note that although only the work memory 44 is illustrated in FIG. 3, the same applies to the weight memory 43.

Considering regularity in the order of accessing the weight memory 43 or the work memory 44 during DNN processing, it is possible to control the memory power with finer granularity to maximize the power-saving effect. The present disclosure proposes a method to reduce memory power consumption on a memory-access basis during DNN processing by utilizing such regularity of memory access.

### <Method Proposed by the Present Disclosure>

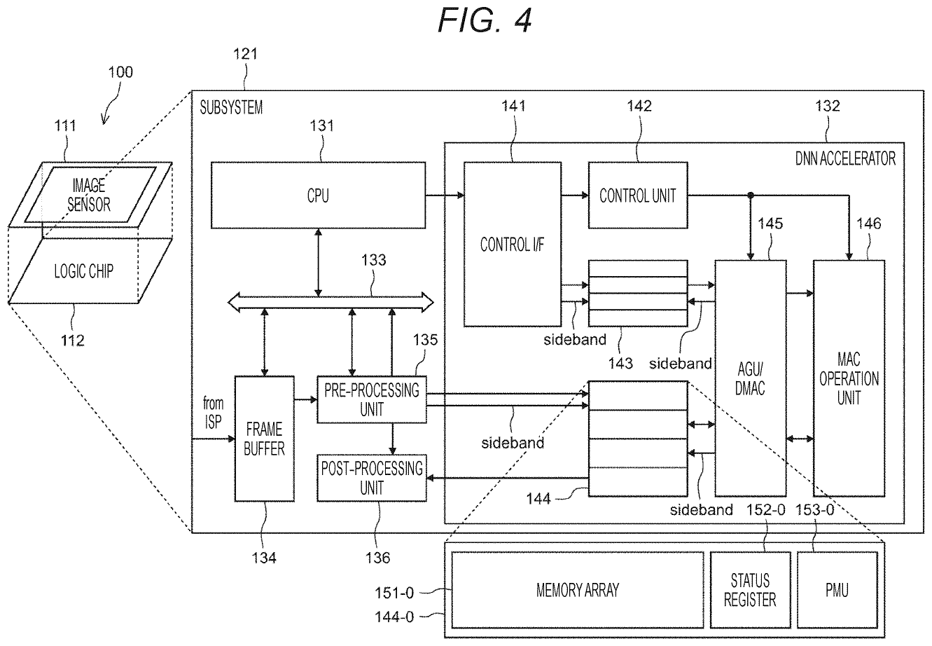

FIG. 4 is a diagram illustrating a configuration example of an embodiment of a sensor system to which the present disclosure is applied. In FIG. 4, a sensor system 100 has a layered structure including an image sensor 111 and a logic chip 112. For example, the sensor system 100 is configured as an edge device such as a sensor device. The logic chip 112 includes a subsystem 121 for DNN processing.

The subsystem 121 includes a CPU 131, a DNN accelerator 132, a bus 133, a frame buffer 134, a pre-processing unit 135, and a post-processing unit 136. The DNN accelerator 132 includes a control I/F 141, a control unit 142, a weight memory 143, a work memory 144, an AGU/DMAC 145, and a MAC operation unit 146.

The CPU 131 controls the operation of the frame buffer 134, the pre-processing unit 135, and the post-processing unit 136 via the DNN accelerator 132 and the bus 133. In the frame buffer 134, pixel signals generated by the image sensor 111 are stored on a frame-by-frame basis through ISP processing. The CPU 131 loads weight values necessary for DNN processing into the weight memory 143 via the control I/F 141.

The CPU 131 loads, into the work memory 144, data of a necessary portion of an input-feature-map that the DNN accelerator 132 can process in a single batch, of the frame of activation stored in the frame buffer 134. Note that, in a case where other processing is required before DNN processing, the pre-processing unit 135 performs the required processing under the control of the CPU 131.

In a state where the weight values have been loaded in the weight memory 143 and the data of the necessary portion of the input-feature-map has been loaded in the work memory 144, the CPU 131 controls the control unit 142 via the control I/F 141 to cause the AGU/DMAC 145 and the MAC operation unit 146 to perform MAC operations in DNN (DNN processing) in accordance with the preset configuration information.

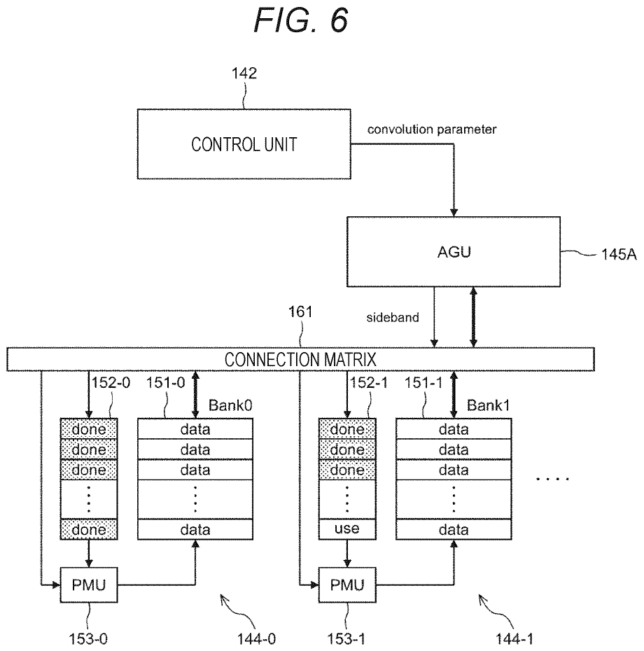

The AGU/DMAC 145 includes an AGU circuit (AGU 145A in FIG. 6 to be described later) and a DMAC circuit. The MAC operation unit 146 is configured with an ALU. The AGU/DMAC 145 fetches operands to be input to the MAC operation unit 146 from the weight memory 143 or the work memory 144, and the operand fetching is repeated until the MAC operations are completed. Partial sums of intermediate results from a plurality of MAC operations are also stored in the work memory 144. An output-feature-map resulting from such MAC operations is output. Note that, in a case where other processing is required before DNN processing, the post-processing unit 136 performs the required processing under the control of the CPU 131.

In the DNN accelerator 132 configured as described above, the work memory 144 is partitioned into a plurality of memory banks, a flag indicating whether or not data stored on a per-memory-word basis in each memory bank has been used is retained and managed, and the power to a memory bank where data stored for all the memory words has been used is brought from the on state into the off state or the low-power state in accordance with the status indicated by the retained flag. The memory word is the unit of data that can be read in a single cycle of memory access (read unit per cycle). In each memory bank, data is stored on a per-memory-word basis. In the memory bank, data stored on a per-memory-word basis may be regarded as a memory word or data stored in a memory word. It can also be said that the flag is usage status information indicating the usage status of data stored on a per-memory-word basis. In FIG. 4, the work memory 144 is partitioned into partitioned memories 144-0 to 144-k (k is an integer greater than or equal to 1) on the basis of the number of partitions in the memory bank.

As illustrated in FIG. 4, the partitioned memory 144-0 corresponds to a memory bank labeled Bank 0. The partitioned memory 144-0 includes a memory array 151-0 corresponding to the memory bank, a status register 152-0 configured with a flip-flop circuit that retains 1-bit information for each memory word, and a power management unit (PMU) 153-0 configured with dedicated hardware for controlling the power to the memory bank. It can also be said that the status register 152-0 and the PMU 153-0 are control peripheral circuits provided for the memory array 151-0.

In accordance with a sideband signal input from the AGU/DMAC 145, the status register 152-0 retains a flag indicating whether or not (data stored in) each memory word has been used. When the memory word has been used, the status register 152-0 retains done (for example, 1) as a flag indicating that the memory word is scheduled not to be in use in the future. Furthermore, when the memory word has not been used yet, the status register 152-0 retains use (for example, 0) as a flag for the memory word. When the flags of all the memory words in the status register 152-0 become done (1), the PMU 153-0 brings the power to the memory bank labeled Bank 0 (the power to the memory array 151-0) from the on state into the off state or the low-power state.

Although the description will be omitted to prevent redundancy, in the work memory 144, the partitioned memories 144-1 to 144-k are configured in a manner similar to the partitioned memory 144-0. That is, the status register 152 and the PMU 153 are provided for each of the memory banks of Bank 1 to Bank k. Note that, in the above description, the configuration has been described where the work memory 144 is partitioned into the plurality of memory banks and the power is managed for each memory bank, and, similarly, the weight memory 143 may be partitioned into a plurality of memory banks and the power may be managed for each memory bank. Furthermore, in the above description, the example has been described where the work memory 144 uses the input sideband signal, and the input sideband signal can be similarly used for the weight memory 143.

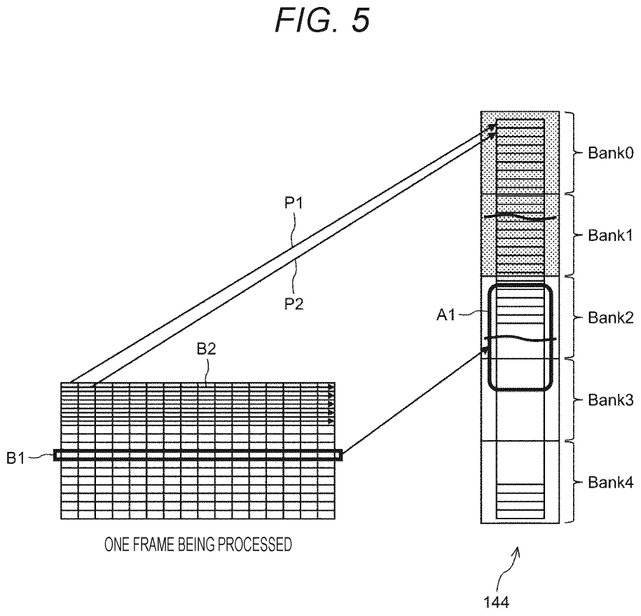

FIG. 5 is a diagram for describing how to reduce memory power consumption in the DNN accelerator 132 illustrated in FIG. 4. In FIG. 5, similar to FIG. 3, each piece of pixel data of (the frame of) activation being processed is stored in the corresponding rectangular area (memory word) in the work memory 144 (P1, P2, . . . in the drawing). Furthermore, a status of access to the work memory 144 at a specific point in time during DNN processing is indicated by a frame A1, and a position of data being accessed on (the frame of) activation is indicated by a frame B1.

As illustrated in FIG. 5, the work memory 144 that stores activation is partitioned into a plurality of memory banks. In the example illustrated in FIG. 5, five memory banks labeled Bank 0 to Bank 4 are illustrated as the plurality of memory banks.

In the work memory 144, each bit of the status register 152 retains, for the corresponding memory word of each memory bank, a flag indicating whether or not a pixel (data) stored in the memory word has been used upon memory access. Then, the PMU 153 determines a memory bank where all the memory words have been used on the basis of the retained flags and brings the power state from the on state into the off state or the low-power state (such as the retention state). In the retention state, data stored on a per-memory-word basis remains accessible between transition from the on state and transition back to the on state.

In the example illustrated in FIG. 5, as indicated by an arrow B2, the frame of activation being processed is sequentially used from the top to the bottom; therefore, the flags of Bank 0 and Bank 1 indicate done (1), and the power to Bank 0 and Bank 1 is the off state or the low-power state. Furthermore, in the example illustrated in FIG. 5, the memory words of Bank 2 and Bank 3 are being accessed; therefore, the power to Bank 2 to Bank 4 is in the on state. As described above, by enabling power control on a per-memory-bank basis, it is possible to bring the power to the used memory bank into the off state or the low-power state. Note that when the memory words of a memory bank that has transitioned to the low-power state (such as the retention state) are accessed again, the memory bank can be brought into (restored to) the on state (normal mode). The power to all the memory banks can initially be set to the on state.

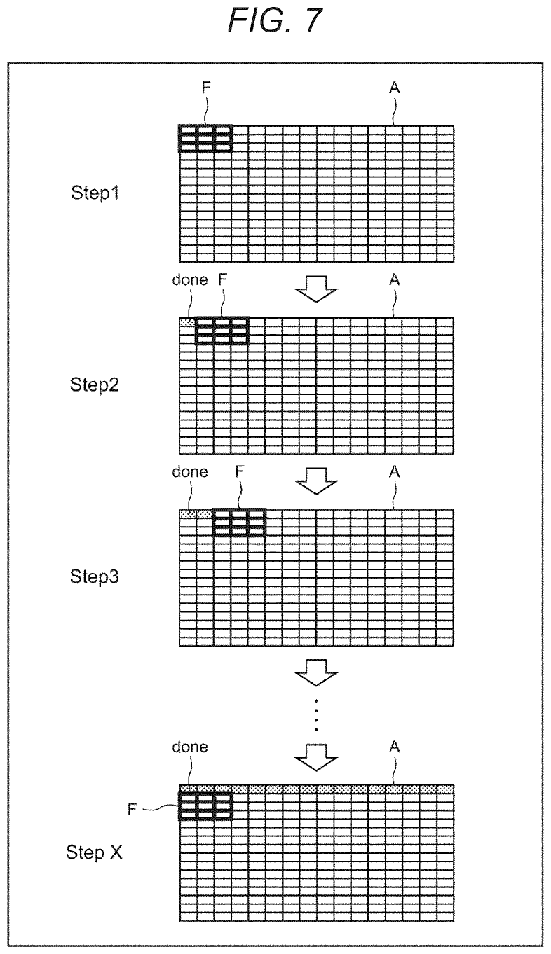

Next, the memory configuration and memory power control implemented in the DNN accelerator 132 illustrated in FIG. 4 will be described in more detail with reference to FIGS. 6 and 7. FIG. 6 is a diagram illustrating a configuration example of the work memory 144 in the DNN accelerator 132. FIG. 7 is a diagram illustrating the order of data usage during convolution in the DNN accelerator 132.

In FIG. 7, as illustrated in each step from Step 1 to Step X, a 3×3 convolution filter F starts at the top-left corner of an input-feature-map as activation A, proceeds in the width direction, and then proceeds in the height direction after reaching the end in the width direction. At this time, when the convolution with the 3×3 matrix is completed for each step, the filter F proceeds to the next step. In FIG. 7, unnecessary pixels in the input-feature-map in each step are marked as “done” in the drawing, and are represented with a dot pattern. To use information regarding such unnecessary pixels, the memory structure illustrated in FIG. 6 is applied to the work memory 144 of the DNN accelerator 132.

FIG. 6 illustrates a configuration example of the work memory 144 as an activation memory that stores the input-feature-map. The work memory 144 is partitioned into a plurality of memory banks like Bank 0, Bank 1, . . . , and (data of) one pixel is stored in one memory word of each memory bank, marked as data in a rectangular area of the memory array 151. In each memory bank, each bit of the status register 152 retains a flag indicating whether or not the pixel in the corresponding memory word has been used.

At the start of the convolution processing, the power to all the memory banks is in the on state. When the convolution processing starts, the AGU 145A of the AGU/DMAC 145 reads pixels of the input-feature-map required for computation from the work memory 144 on the basis of the convolution parameters (for example, the parameters described in FIG. 1) set in the control unit 142, and supplies the pixels to the MAC operation unit 146. As the convolution processing progresses, unnecessary pixels emerge. The AGU 145A iterates an address computation loop using dedicated hardware, and thus can compute at which point in time the pixel at a specific address becomes unnecessary.

The AGU 145A issues an address used to read the corresponding pixel in the last cycle, and at the same time, notifies the work memory 144 that the corresponding pixel has been used using a sideband signal of a connection matrix 161 of the work memory 144. The connection matrix 161 is, for example, an advanced high-performance bus (AHB). The status register 152 receives the sideband signal from the AGU 145A, and sets a flag done (1) on the corresponding memory word bit, indicating that the pixel is scheduled not to be in use in the future. Furthermore, in a case where the sideband signal is 0, the status register 152 does not update the corresponding memory word bit.

The PMU 153 is implemented to control the power to each memory bank, and brings, when all the memory word bits of the status register 152 of a specific memory bank become done (1), the power to the memory bank into the off state. For example, in FIG. 6, in the memory bank labeled Bank 0, when all the pixels stored in each memory word have been used (for example, the state of Step X in FIG. 7), all the bits of the status register 152-0 become done (1), causing the PMU 153-0 to bring the power to the memory bank into the off state.

Note that in a case where one cycle of convolution is completed and new data is loaded into the same bank again for reuse, the power to the memory bank may be in the off state; however, in a case where the same data needs to be used again, for example, when another filter is used for the same input-feature-map, the power to the memory bank may be in the low-power state such as the retention state where data is retained, instead of the off state.

As a method for initializing the status register 152, for example, the following method can be used. As a first method, each bit of the status register 152 is automatically initialized to 0 as its initial value upon reset release. However, in a case where a specific area in the same memory bank is intentionally unused, it is only required for the CPU 131 to directly set the corresponding bit of the status register 152 to 1. As a second method, each bit of the status register 152 is automatically initialized to 1 as its initial value upon reset release, and when loading the input-feature-map before convolution, only a required memory word bit of the status register 152 may be set to 0 through the sideband signal.

A memory bank that has once entered the off state or the retention state may be set to the on state under the control of the CPU 131 before the next convolution, or the PMU 153 may detect a subsequent access to the memory bank through the sideband signal to set the power to the on state.

Note that, in the example illustrated in FIG. 6, in the memory bank labeled Bank 1, all the pixels stored in each memory word have not been used yet and not all the bits of the status register 152-1 have been set to done (1) (the bits include a bit set to use (0)); therefore, the power to the memory bank remains in the on state. Thereafter, when all the pixels stored in each memory word of the memory bank labeled Bank 1 have been used and all the bits of the status register 152-1 have been set to done (1), the PMU 153-1 brings the power to the memory bank into the off state or the retention state.

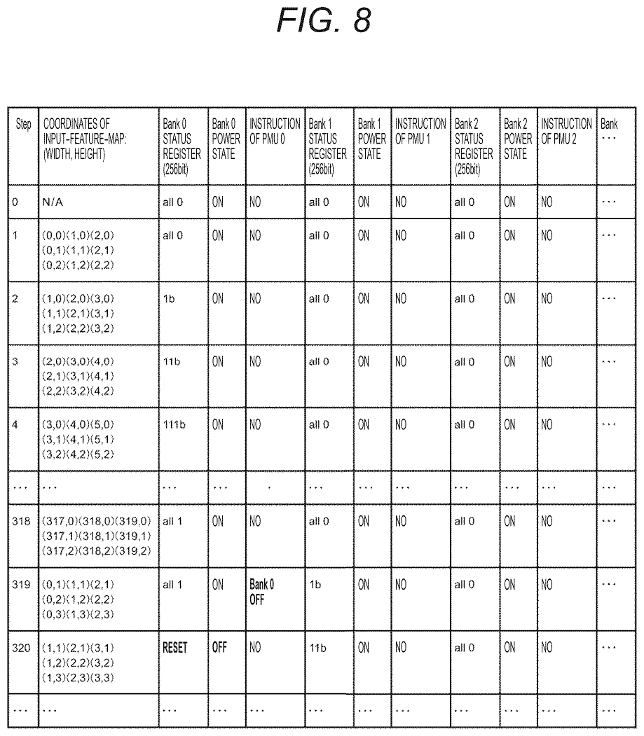

FIG. 8 is a diagram illustrating a relationship among the value of the status register 152, the instruction of the PMU 153, and the power state of each memory bank for each step of convolution. FIG. 8 illustrates the states of three memory banks labeled Bank 0, Bank 1, and Bank 2 among the plurality of memory banks.

FIG. 8 illustrates states in several steps when convolution is performed on a quarter video graphics array (QVGA) image (320×240) using a 3×3 filter. The data format of the input-feature-map is set to 32-bit float, and the size of the memory bank in the work memory 144 is set to 320×4 bytes. For the sake of simplifying the description, the bandwidth of the memory bank is set to 1 pixel per cycle. Each 3×3 convolution step requires nine pixels in the input-feature-map and takes nine cycles. In FIG. 8, the nine cycles are described as one step.

In FIG. 8, in Step 0 to 317, not all the bits of the status register 152-0 of the memory bank labeled Bank 0 have been set to done (1), the instruction of the PMU 153-0 is set to “none”, and the power to Bank 0 remains in the on state. In Step 318, all the bits of the status register 152-0 of Bank 0 have been set to done (1), the instruction of the PMU 153-0 is set to “Bank 0 off” in Step 319. Then, in Step 320, the power to the memory bank labeled Bank 0 enters the off state, and each bit of the status register 152-0 of Bank 0 is reset. That is, in Step 318, all the pixels stored in each memory word of the memory bank labeled Bank 0 have been used, and, in Step 319, the processing proceeds to the next line on the input-feature-map.

### <Control Flow>

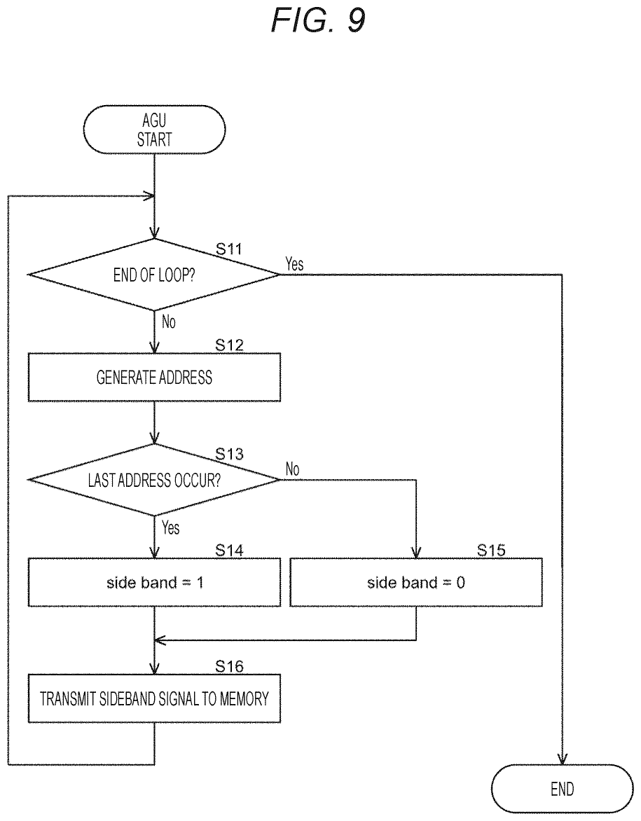

FIG. 9 is a diagram illustrating a control flow of the AGU 145A.

The AGU 145A determines whether or not the loop has been completed (S11), and generates an address in a case where the loop has not completed (S12). Furthermore, the AGU 145A determines whether or not the generated address no longer occurs thereafter and the last address has occurred (S13).

The AGU 145A sets 1 (done) to the sideband signal in a case where the last address has occurred (S14), and sets 0 to the sideband signal in a case where the last address has not occurred (S15). Then, the AGU 145A transmits, to the work memory 144, the sideband signal indicating 1 or 0 (S16).

When step S16 is completed, the processing returns to step S11, and steps S11 to S16 are repeated until the loop is determined to be completed. In a case where the loop is determined to be completed in step S11, the series of processing comes to an end.

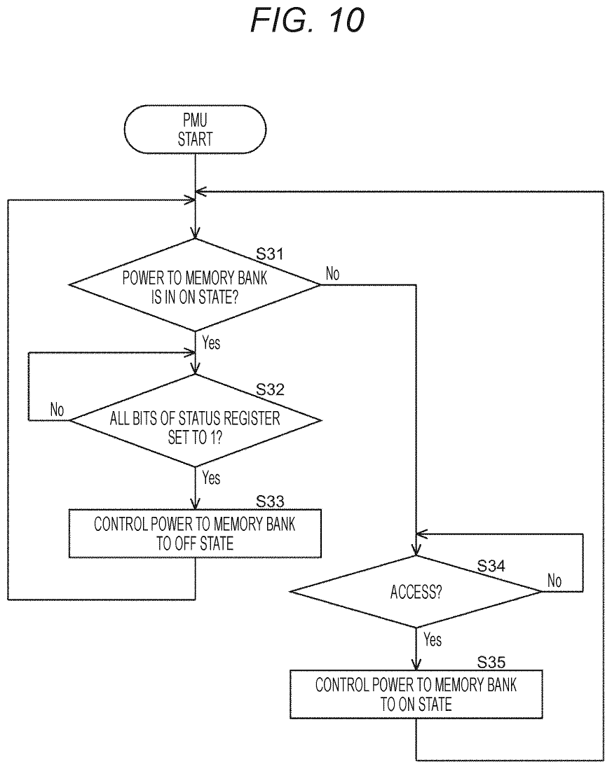

FIG. 10 is a diagram illustrating a control flow of the PMU 153.

The PMU 153 determines whether or not the power to the memory bank is in the on state (S31) and determines, in a case where the power to the memory bank is in the on state, whether or not all the bits of the status register 152 have been set to 1 (done) (S32). In a case where not all the bits of the status register 152 have been set to 1, the power to the memory bank remains in the on state. On the other hand, in a case where all the bits of the status register 152 have been set to 1, the PMU 153 controls the power to the memory bank to the off state (S33). Here, the power to the memory bank may be brought into the low-power state such as the retention state instead of the off state.

When step S33 is completed, the processing returns to step S31. Then, in a case where the power to the memory bank is not in the on state, the PMU 153 determines whether or not there is access to the memory bank that is in the off state or the low-power state (S34). Then, in a case where there is access to the memory bank that is in the off state or the low-power state, the PMU 153 controls the power to the memory bank to the on state (S35). Here, in a case where the power to the memory bank is in the retention state, the power is controlled and returned to the normal mode. When step S35 is completed, the processing returns to step S31, and the above-described processes are repeated.

As described above, according to the present disclosure, it is possible to reduce memory power consumption on a memory-access basis during DNN processing. That is, since the memory banks used in sequence automatically enters the off state or the low-power state, it is possible to reduce leakage power. Furthermore, since the memory bank with power turned on has a small memory array compared to a conventional case where there is no partitioning into memory banks, the dynamic power of memory access can be reduced. Although partitioning a memory into a plurality of memory banks causes overhead in the peripheral circuits, if an appropriate bank size is selected by taking into consideration the type of the memory and the generation of the complementary metal oxide semiconductor (CMOS) process (trade-offs involved in partitioning the memory into the plurality of memory banks), the power-saving effect can outweigh the overhead.

Furthermore, by implementing the functionality of the status register 152 and the PMU 153 on the memory side such as the work memory 144, instead of on the AGU/DMAC 145 (AGU 145A) side, it is possible to enhance the reusability of the design. For example, in a case where another chip, designed with expanded memory capacity, is manufactured for the same system, by simply increasing the number of status registers 152, it is possible to reuse the circuitry of the AGU/DMAC 145 (AGU 145A) without modification, which leads to lower design costs.

### <Modifications>

### <<First Modification>>

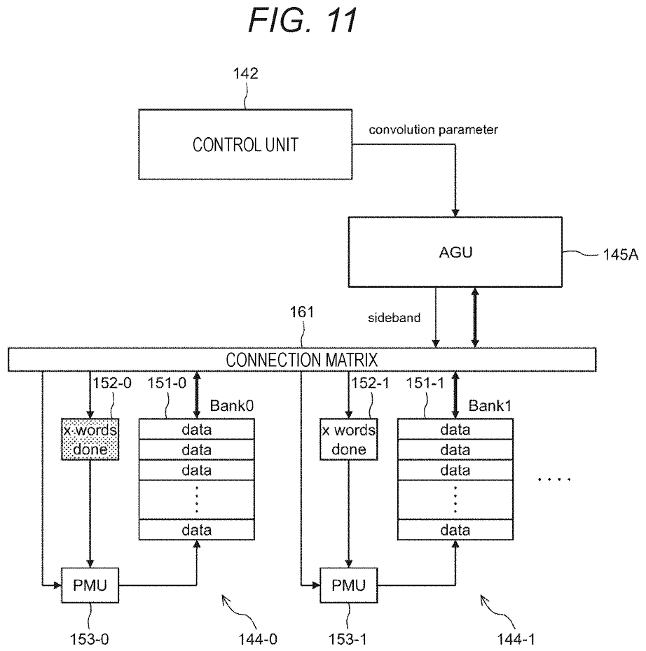

FIG. 11 is a diagram for describing another example of the memory configuration implemented in the DNN accelerator 132.

The power control may be performed on a per-memory-bank basis with the status register 152 of each memory bank retaining the total number of unnecessary memory words in the memory bank, rather than retaining a flag for each memory word using 1 bit. In FIG. 11, the status register 152 is configured with log 2 (n) bits instead of n bits. Here, n represents the number of memory words of each memory bank.

In FIG. 11, the status register 152 retains the total number of unnecessary memory words in the memory bank by incrementing the number by 1 each time an unused memory word is added. When the total number of unnecessary memory words retained in the status register 152 becomes equal to n (Status Register=n), the PMU 153 brings the power to the memory bank from the on state into the off state or the low-power state. It can also be said that the total number of unnecessary memory words in the memory bank is usage status information indicating the usage status of data stored on a per-memory-word basis.

For example, in FIG. 11, when the pixels (data) stored in each memory word of the memory bank labeled Bank 0 have been used, the total number of unnecessary memory words retained in the status register 152-0 becomes equal to n, causing the PMU 153-0 to bring the power to the memory bank into the off state. Furthermore, all the pixels stored in each memory word of the memory bank labeled Bank 1 have not been used, and the total number of unnecessary memory words retained in the status register 152-1 has not reached n, maintaining the power to the memory bank in the on state. Thereafter, when all the pixels stored in each memory word of the memory bank labeled Bank 1 have been used and the total number of unnecessary memory words retained in the status register 152-1 becomes equal to n, the PMU 153-1 brings the power to the memory bank into the off state.

As described above, the configuration illustrated in FIG. 11 where the status register 152 of each memory bank retains the total number of unnecessary words in the memory bank can achieve a similar power-saving effect with a simple circuit configuration compared to the configuration illustrated in FIG. 6 described above.

### <<Second Modification>>

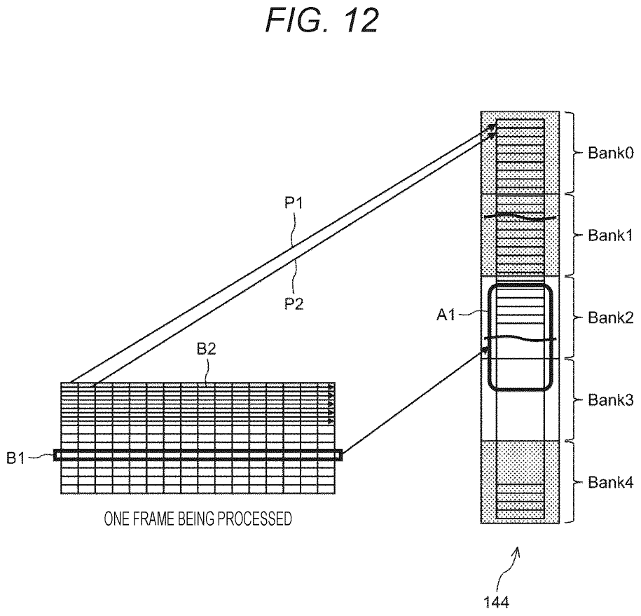

FIG. 12 is a diagram for describing another example of the memory power control implemented in the DNN accelerator 132.

The power to each memory bank may be initially set to the off state or the low-power state (such as the retention state), instead of setting all the memory banks to the on state. To enable such control, the PMU 153 needs to activate and use a required memory bank when access occurs. Unlike the configuration illustrated in FIG. 5 described above, the initial value of the status register 152 remains unchanged during the initial off state or low-power state. Thereafter, the status register 152 is reset for the first time when the convolution processing progresses, and the PMU 153 brings the power to the corresponding memory bank into the off state.

In FIG. 12, similar to FIG. 5 described above, each piece of pixel data of (the frame of) activation is stored in the corresponding rectangular area (memory word) in the work memory 144 (P1, P2, . . . in the drawing). Furthermore, a status of access to the work memory 144 at a specific point in time during DNN processing is indicated by a frame A1, and a position of data being accessed on (the frame of) activation is indicated by a frame B1.

Five memory banks labeled Bank 0 to Bank 4 are illustrated in FIG. 12, and the power to each memory bank is initially set to the off state or the low-power state. As indicated by an arrow B2, the frame of activation being processed is sequentially used from the top to the bottom; therefore, all the pixels stored in each memory word of Bank 0 and Bank 1 have been used, and the power to Bank 0 and Bank 1 is in the off state or the low-power state. That is, although the power to Bank 0 and Bank 1 is initially set to the off state or the low-power state, the power is brought into the on state by the PMU 153 when access occurs, and is then brought into the off state or the low-power state when the pixels stored in each memory word have been used. At this time, the status registers 152 of Bank 0 and Bank 1 are reset.

The power to Bank 2 and Bank 3 is initially set to the off state or the low-power state, but is controlled by the PMU 153 to transition to the on state when access is detected. The power to Bank 4 is initially set to the off state or the low-power state. At this time, the status register 152 of Bank 4 has not been reset, that is, the reset is canceled, enabling the initial value (for example, 0) to be read by the PMU 153. As described above, not only the memory banks that have been used (Bank 0, Bank 1) but also the memory bank (Bank 4) located downstream of the memory banks (Bank 2, Bank 3) being accessed is set to the off state or the low-power state, which makes it possible to enhance the power-saving effect.

### <<Third Modification>>

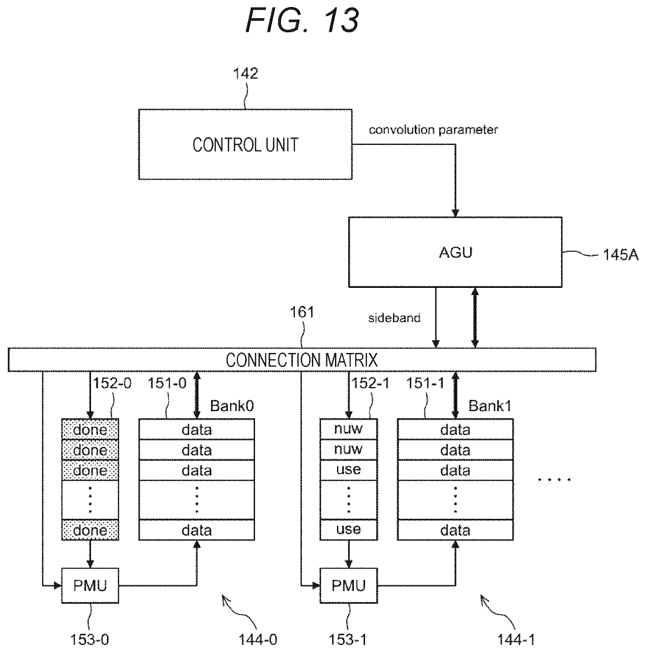

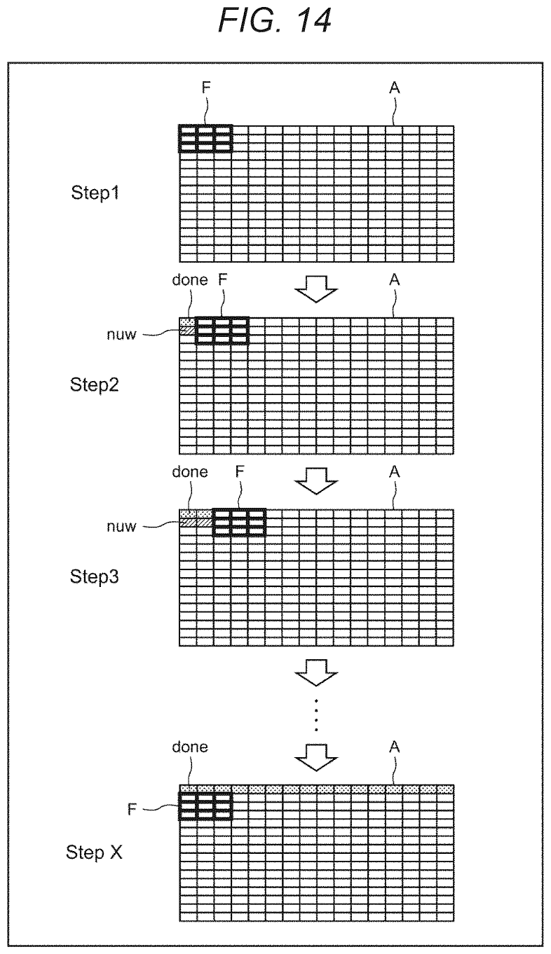

FIGS. 13 and 14 are diagrams for describing another example of the memory configuration and the memory power control implemented in the DNN accelerator 132. FIG. 13 is a diagram for describing still another example of the memory configuration implemented in by the DNN accelerator 132. FIG. 14 is a diagram illustrating the order of data usage during convolution adapted to the memory configuration illustrated in FIG. 13.

It is possible to not only retain a flag for a memory word that has been used but also set a flag for a memory word that has not been used but is scheduled not to be in use for a while (scheduled not to be in use for a predetermined period of time). By selectively using such flags, it is possible to bring more memory banks into the low-power state (such as the retention state). In a case where a memory word that has been used and a memory word that is scheduled not to be in use for a while are both present in the same memory bank, it is only required to set the power to the memory bank to the retention state. Then, when all the memory words of the memory bank have been used, it is only required to set the power to the off state.

In FIG. 13, the status register 152 has a bit width of 2 bits per memory word to represent a flag indicating nuw (not in use for a while) in addition to done (1) and use (0). In FIG. 13, upon receipt of the sideband signal from the AGU 145A, the status register 152 can set a flag indicating nuw, that is, a flag indicating that the corresponding memory word has not been used but is scheduled not to be in use for a while, in 2 bits for the memory word. In a case where there is no flag indicating use, but a flag indicating done and a flag indicating nuw are both present in the status register 152 of the memory bank, the PMU 153 brings the power to the memory bank into the retention state.

For example, in FIG. 13, in the memory bank labeled Bank 0, when all the pixels stored in each memory word have been used, all the sets of 2 bits of the status register 152-0 indicate done (1), causing the PMU 153-0 to turn the power to the memory bank into the power-off state. Furthermore, in the memory bank labeled Bank 1, the flag indicating nuw is set in 2 bits of the status register 152-1 for a memory word that is scheduled not to be in use for a predetermined period of time.

Here, similar to FIG. 7 described above, FIG. 14 illustrates a state where the 3×3 filter F starts at the top-left corner of the input-feature-map as activation A, proceeds in the width direction, and then proceeds in the height direction after reaching the end in the width direction. When the state of Step 3 illustrated in FIG. 14 corresponds to the sets of 2 bits of the status register 152-1 illustrated in FIG. 13, each pixel indicated by “nuw” in Step 3 in FIG. 14 is a pixel that has not been used but is scheduled not to be in use for a while, and thus the flag indicating nuw is set in the corresponding 2 bits.

Then, for example, in a case where a memory word that has been used and a memory word that is scheduled not to be in use for a while are both present in the memory bank labeled Bank 1, the flag indicating done and the flag indicating nuw are both present in the sets of 2 bits of the status register 152-1, causing the PMU 153-1 to bring the power to the memory bank into the retention state. Alternatively, in the memory bank labeled Bank 1, in a case where all the pixels stored in each memory word have been used, all the sets of 2 bits of the status register 152-1 indicate done (1); therefore, it is only required for the PMU 153-1 to bring the power to the memory bank into the off state. Note that, in a case where the memory bank labeled Bank 1 only has memory words that are scheduled not to be in use for a while, all the sets of 2 bits of the status register 152-1 indicate nuw, enabling the PMU 153-1 to bring the power to the memory bank into the retention state.

FIG. 13 illustrates a configuration where the status register 152 has a bit width of 2 bits per memory word; however, similar to the configuration illustrated in FIG. 6 described above, in a case where the bit width is 1 bit, it is only required to use the retention state as the power state of the memory bank without using the off state. This eliminates the need for distinguishing between done and nuw, and it is therefore sufficient to distinguish between 0 (use) and 1 (done, nuw), which can be represented with 1 bit.

### Other Configuration Examples

In the above, the configuration where the work memory 144 is partitioned into a plurality of memory banks and the power state of each memory bank is controlled on the basis of the usage status of data stored in each memory word of the memory bank has been mainly described; however, the configuration is not limited to being applied to the work memory 144 and may be similarly applied to another memory such as the weight memory 143.

That is, the weight memory 143 is partitioned into a plurality of memory banks, the status register and the PMU are provided memory bank for each memory bank, and the flag based on the sideband signal transmitted from the AGU 145A and the total number of memory words based on data that has been used are retained, which makes it possible to control the power state of each memory bank under the control of the PMU. The configuration described above is applicable to at least one of the work memory 144 or the weight memory 143. Note that the sideband signal is a signal that complies with a specific standard, but other signals may be used as long as they can update the value retained in the status register.

In the above, the case where activation such as an input-feature-map is two-dimensional in width and height has been described as an example; however, the processing can similarly be performed in the channel direction. That is, by storing images (two-dimensional images) for each channel one by one in a single memory bank, it is possible to process the images for each channel in a similar manner. The input-feature-map and the output-feature-map are examples of features.

In the present disclosure, a system is defined as a logical assembly of a plurality of devices, and is assumed to include, for example, devices (chips or the like) housed in the same housing. In FIG. 4, the DNN accelerator 132 may be regarded as a data processing device that processes data stored in a memory, and the subsystem 121 may be regarded as a data processing system including the DNN accelerator 132 configured as the data processing device. For example, the subsystem 121 can be configured as a single-core or multi-core processor system including a processor such as the CPU 131 and a coprocessor, and the DNN accelerator 132. The sensor system 100 equipped with such processor systems can be configured as a sensor device or an edge device. Note that the sensor system 100 may include not only the image sensor 111 but also other sensors such as a depth sensor and a ranging sensor. Furthermore, data used by the DNN accelerator 132 may be not for DNN processing.

Note that the embodiment of the present disclosure is not limited to the above-described embodiments, and various modifications can be made without departing from the gist of the present disclosure. Furthermore, the effects described herein are merely examples and are not intended to be limiting, and other effects may also be possible.

Furthermore, the present disclosure may have the following configurations.

(1)

A data processing device including:
a memory that is partitioned into a plurality of memory banks and stores data used in DNN processing;
a holding unit that is provided for each of the memory banks and retains usage status information indicating a usage status of the data stored in each memory word; and
a power management unit that brings power to the memory bank where all the pieces of data stored in each memory word have been used from an on state into an off state or a low-power state where the memory banks operate with reduced power compared to the on state on the basis of the usage status information that has been retained.
   (2)

The data processing device according to the above (1), in which
the usage status information includes a flag indicating a status of whether or not the data stored in each memory word has been used, and
in a case where the flag that has been retained indicates that all the pieces of data stored in each memory word of each of the memory banks have been used, the power management unit brings power to the memory bank equipped with the holding unit retaining the flag from the on state into the off state or the low-power state.
   (3)

The data processing device according to the above (1), in which
the usage status information includes a total number of the memory words based on the data that has been used for each of the memory banks, and
when the total number that has been retained becomes equal to a number of the memory words of each of the memory banks, the power management unit brings power to the memory bank equipped with the holding unit retaining the total number from the on state into the off state or the low-power state.
   (4)

The data processing device according to the above (1), in which
in the low-power state, the data stored in each memory word remains accessible between transition from the on state and transition back to the on state, and when the data stored in each memory word of the memory bank that has transitioned from the on state to the low-power state is accessed again, the power management unit brings power to the memory bank into the on state.
   (5)

The data processing device according to any one of the above (1) to (4), in which
power to each of the memory banks is initially set to the on state, and
the power management unit brings power to the memory bank where all the pieces of data stored in each memory word have been used from the on state into the off state or the low-power state on the basis of the usage status information that has been retained.
   (6)

The data processing device according to any one of the above (1) to (4), in which
power to each of the memory banks is initially set to the off state or the low-power state, and
when the data stored in each memory word of each of the memory banks is accessed, the power management unit brings power to the memory bank from the off state or the low-power state into the on state, and
the power management unit brings power to the memory bank where all the pieces of data stored in each memory word have been used from the on state into the off state or the low-power state on the basis of the usage status information that has been retained.
   (7)

The data processing device according to the above (2), in which
the flag further indicates a status where the data stored in each memory word is scheduled not to be in use for a predetermined period of time, and
in a case where the flag that has been retained indicates that each piece of data stored in each memory word of each of the memory banks has been used or is scheduled not to be in use for a predetermined period of time, the power management unit brings power to the memory bank from the on state into the low-power state.
   (8)

The data processing device according to any one of the above (1) to (4), in which
the holding unit retains the usage status information based on a signal transmitted from an address generation unit that generates an address used to read and write data from and to the memory.
   (9)

The data processing device according to any one of the above (1) to (4), in which
the data includes feature map data used in the DNN processing.
   (10)

A data processing method including:
causing a data processing device to retain, for each memory bank obtained by partitioning a memory that stores data used in DNN processing into a plurality of the memory banks, usage status information indicating a usage status of the data stored in each memory word; and
causing the data processing device to bring power to the memory bank where the all the pieces of data stored in each memory word have been used from an on state into an off state or a low-power state where the memory banks operate with reduced power compared to the on state on the basis of the usage status information that has been retained.
   (11)

A data processing system including:
a processor;
a buffer that stores data received from outside; and
a data processing device that is controlled by the processor and to which the data stored in the buffer is input, in which
the data processing device includes:
   a memory that is partitioned into a plurality of memory banks and stores data used in DNN processing;
   a holding unit that is provided for each of the memory banks and retains usage status information indicating a usage status of the data stored in each memory word; and
   a power management unit that brings power to the memory bank where all the pieces of data stored in each memory word have been used from an on state into an off state or a low-power state where the memory banks operate with reduced power compared to the on state on the basis of the usage status information that has been retained.
      (12)

A sensor system including:
a sensor; and
a data processing system that processes data received from the sensor, in which
the data processing system includes:
   a processor;
   a buffer that stores the data received from the sensor; and
   a data processing device that is controlled by the processor and to which the data stored in the buffer is input, and
the data processing device includes:
   a memory that is partitioned into a plurality of memory banks and stores data used in DNN processing;
   a holding unit that is provided for each of the memory banks and retains usage status information indicating a usage status of the data stored in each memory word; and
   a power management unit that brings power to the memory bank where all the pieces of data stored in each memory word have been used from an on state into an off state or a low-power state where the memory banks operate with reduced power compared to the on state on the basis of the usage status information that has been retained.
      (13)

The sensor system according to the above (12), in which
the sensor includes an image sensor.

### REFERENCE SIGNS LIST

100 Sensor system
111 Image sensor
112 Logic chip
121 Subsystem
131 CPU
132 DNN accelerator
133 Bus
134 Frame buffer
135 Pre-processing unit
136 Post-processing unit
141 Control I/F
142 Control unit
143 Weight memory
144 Work memory
144-0, 144-1 Partitioned memory
145 AGU/DMAC
145A AGU
146 MAC operation unit
151-0, 151-1 Memory array
152-0, 152-1, 152 Status register
153-0, 153-1, 153 PMU
161 Connection matrix

1. A data processing device comprising:
a memory that is partitioned into a plurality of memory banks and stores data used in DNN processing;
a holding unit that is provided for each of the memory banks and retains usage status information indicating a usage status of the data stored in each memory word; and
a power management unit that brings power to the memory bank where all the pieces of data stored in each memory word have been used from an on state into an off state or a low-power state where the memory banks operate with reduced power compared to the on state on a basis of the usage status information that has been retained.

2. The data processing device according to claim 1, wherein
the usage status information includes a flag indicating a status of whether or not the data stored in each memory word has been used, and
in a case where the flag that has been retained indicates that all the pieces of data stored in each memory word of each of the memory banks have been used, the power management unit brings power to the memory bank equipped with the holding unit retaining the flag from the on state into the off state or the low-power state.

3. The data processing device according to claim 1, wherein
the usage status information includes a total number of the memory words based on the data that has been used for each of the memory banks, and
when the total number that has been retained becomes equal to a number of the memory words of each of the memory banks, the power management unit brings power to the memory bank equipped with the holding unit retaining the total number from the on state into the off state or the low-power state.

4. The data processing device according to claim 1, wherein
in the low-power state, the data stored in each memory word remains accessible between transition from the on state and transition back to the on state, and
when the data stored in each memory word of the memory bank that has transitioned from the on state to the low-power state is accessed again, the power management unit brings power to the memory bank into the on state.

5. The data processing device according to claim 1, wherein
power to each of the memory banks is initially set to the on state, and
the power management unit brings power to the memory bank where all the pieces of data stored in each memory word have been used from the on state into the off state or the low-power state on a basis of the usage status information that has been retained.

6. The data processing device according to claim 1, wherein
power to each of the memory banks is initially set to the off state or the low-power state, and
when the data stored in each memory word of each of the memory banks is accessed, the power management unit brings power to the memory bank from the off state or the low-power state into the on state, and
the power management unit brings power to the memory bank where all the pieces of data stored in each memory word have been used from the on state into the off state or the low-power state on a basis of the usage status information that has been retained.

7. The data processing device according to claim 2, wherein
the flag further indicates a status where the data stored in each memory word is scheduled not to be in use for a predetermined period of time, and
in a case where the flag that has been retained indicates that each piece of data stored in each memory word of each of the memory banks has been used or is scheduled not to be in use for a predetermined period of time, the power management unit brings power to the memory bank from the on state into the low-power state.

8. The data processing device according to claim 1, wherein
the holding unit retains the usage status information based on a signal transmitted from an address generation unit that generates an address used to read and write data from and to the memory.

9. The data processing device according to claim 1, wherein
the data includes feature map data used in the DNN processing.

10. A data processing method comprising:
causing a data processing device to retain, for each memory bank obtained by partitioning a memory that stores data used in DNN processing into a plurality of the memory banks, usage status information indicating a usage status of the data stored in each memory word; and
causing the data processing device to bring power to the memory bank where the all the pieces of data stored in each memory word have been used from an on state into an off state or a low-power state where the memory banks operate with reduced power compared to the on state on a basis of the usage status information that has been retained.

11. A data processing system comprising:
a processor;
a buffer that stores data received from outside; and
a data processing device that is controlled by the processor and to which the data stored in the buffer is input, wherein
the data processing device includes:
a memory that is partitioned into a plurality of memory banks and stores data used in DNN processing;
a holding unit that is provided for each of the memory banks and retains usage status information indicating a usage status of the data stored in each memory word; and
a power management unit that brings power to the memory bank where all the pieces of data stored in each memory word have been used from an on state into an off state or a low-power state where the memory banks operate with reduced power compared to the on state on a basis of the usage status information that has been retained.

12. A sensor system comprising:
a sensor; and
a data processing system that processes data received from the sensor, wherein
the data processing system includes:
a processor;
a buffer that stores the data received from the sensor; and
a data processing device that is controlled by the processor and to which the data stored in the buffer is input, and
the data processing device includes:
a memory that is partitioned into a plurality of memory banks and stores data used in DNN processing;
a holding unit that is provided for each of the memory banks and retains usage status information indicating a usage status of the data stored in each memory word; and
a power management unit that brings power to the memory bank where all the pieces of data stored in each memory word have been used from an on state into an off state or a low-power state where the memory banks operate with reduced power compared to the on state on a basis of the usage status information that has been retained.

13. The sensor system according to claim 12, wherein
the sensor includes an image sensor.
